(19) United States
(12) Patent Application Publication
(10) Pub. No.: US 2024/0303711 A1
(43) Pub. Date: Sep. 12, 2024

(54) CONVERSATIONAL AND INTERACTIVE SEARCH USING MACHINE LEARNING BASED LANGUAGE MODELS

(71) Applicant: Maplebear Inc., San Francisco, CA (US)

(72) Inventors: Li Tan, Fremont, CA (US); Tejaswi Tenneti, San Carlos, CA (US); Shishir Kumar Prasad, Fremont, CA (US); Huapu Pan, Scarsdale, NY (US); Allan Stewart, Berkeley, CA (US); Taesik Na, Issaquah, WA (US); Tyler Russell Tate, Lexington, KY (US); Joshua Roberts, San Francisco, CA (US); Haixun Wang, Bellevue, WA (US)

(21) Appl. No.: 18/596,592

(22) Filed: Mar. 5, 2024

Related U.S. Application Data
(60) Provisional application No. 63/450,201, filed on Mar. 6, 2023.

(51) Int. Cl. G06Q 30/0601; G06F 16/9532

(52) U.S. Cl. CPC G06Q 30/0627; G06F 16/9532; G06Q 30/0635

(57) ABSTRACT

A system, for example, an online system uses a machine learning based language model, for example, a large language model (LLM) to process high-level natural language queries received from users. The system receives a natural language query from a user of a client device. The system determines contextual information associated with the query. Based on this information, the system generates a prompt for the machine learning based language model. The system receives a response from the machine learning based language model. The system uses the response to generate a search query for a database. The system obtains results returned by the database in response to the search query and provides them to the user. The system allows users to specify high level natural language queries to obtain relevant search results, thereby improving the overall user experience.

### CROSS-REFERENCE TO RELATED APPLICATIONS

This application claims the benefit of U.S. Provisional Application No. 63/450,201, filed on Mar. 6, 2023, which is incorporated herein in its entirety.

### TECHNICAL FIELD

One or more aspects described herein relate generally to searching, for example, performing searches via databases or search engines, and more specifically to using machine learning based language models for enhancing search queries.

### BACKGROUND

Systems such as online systems often store data in repositories such as file systems and databases. These systems often allow users to perform searches in the stored data. Performing effective searches typically requires expertise, for example, expertise in handling underlying technology or knowledge of the structure or type of data that is stored. The system may be used by users that are not comfortable with new technology or lack knowledge of the data stored. A user without detailed knowledge of the data stored may not be able to ask detailed queries to obtain relevant results. As a result, a user may not be able to ask search queries that provide the response that the user is looking for. Systems typically are not able to answer very broad queries from a user that do not identify specific search terms or the right type of search query. Alternatively, the system may return irrelevant responses to the user. Receiving irrelevant responses provides poor user experience.

### SUMMARY

In accordance with one or more aspects of the disclosure, a system, for example, an online system receives and processes search queries. The system receives a natural language query from a client device of a user. The system determines contextual information associated with the natural language query. Examples of contextual information include user profile information of the user, previous purchases of the user, browsing history of the user, and so on. The system generates a prompt for input to a machine learning based language model based on the natural language query and the contextual information. The system provides the prompt to the machine learning based language model for execution and receives a response from the machine learning based language model. The response may include a set of attributes, for example, specific details of types of items that the user may be interested in purchasing via shopping. The system generates a search query based on the set of attributes and sends the search query for execution, for example, using a database or a search engine. The system receives search results in response to the search query and sends the search results to the client device.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for processing queries received from users, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A system, for example, an online system uses a machine learning based language model, for example, a large language model (LLM) to understand a user's intent behind a complex query. The system receives high level requests from users that do not specify search keywords that can match the underlying data. For example, a user may specify using a natural language interface to search for products for use as a gift for a particular occasion. Accordingly, the user request fails to specify individual items or types of items that the user is searching for and instead specifies high-level intent of the search. The system prompts the machine learning based language model with a user's query and a request to extract various attributes from that query. The prompt may include contextual information about the user and the user's current session. The system receives information from the machine learning based language model that can be used to enhance the search query to obtain better search results. For example, the system may obtain additional attributes that can be specified with the search query to make the search query detailed. The system may obtain items or item types relevant to the user's intent and perform detailed searches for the items or item types. The revised search query may include tagged terms and additional terms for a search, and may be provided to a search engine or a database to retrieve a ranked list of relevant items responsive to the user query.

The techniques disclosed herein improve the search technology by allowing users to ask high-level unstructured queries that may not specify search keywords that match the data being searched or queries that are not structured to conform to specific formats or syntax. Furthermore, the techniques disclosed improve the quality and relevance of the search results by adding appropriate keywords to the search query or revising the search query by adding additional information relevant to user request. Accordingly, the techniques improve user experience.

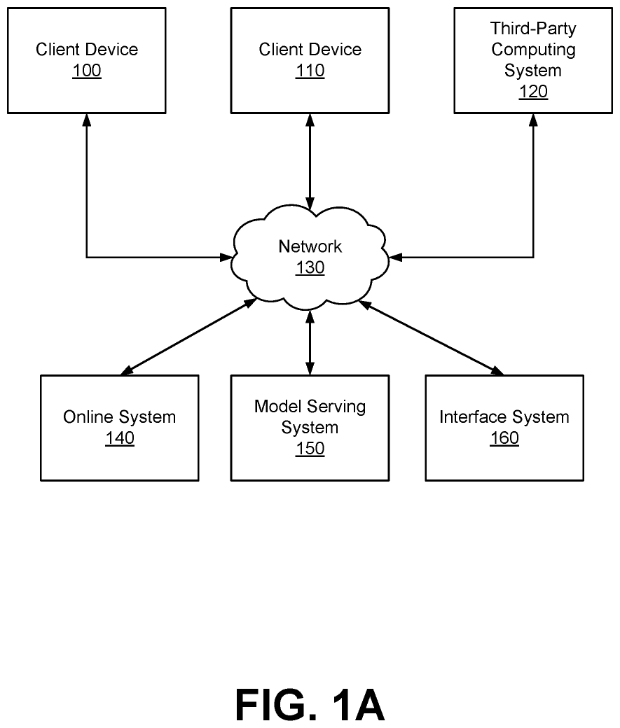

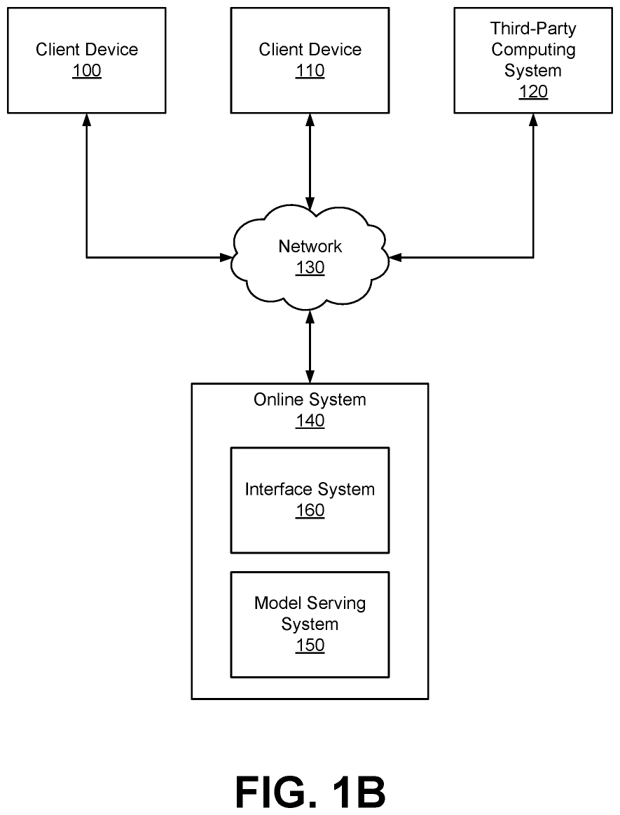

FIG. 1A illustrates an example system environment for an online system 140, in accordance with one or more embodiments. The system environment illustrated in FIG. 1A includes client devices 100, 110, a third-party computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention. Additionally, any number of client devices may interact with the online system 140.

The client device 100 is a client device through which a user may interact with another client device 110, the third-party computing system 120, or the online system 140. The client device 100 can be a personal or mobile computing device, such as a smartphone, a tablet, a laptop computer, or desktop computer. In some embodiments, the client device 100 executes a client application that uses an application programming interface (API) to communicate with the online system 140.

A user uses the client device 100 to place an order with the online system 140. An order specifies a set of items to be delivered to the user. An “item”, as used herein, means a good or product that can be provided to the user through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The client device 100 presents a user interface that allows the user to perform actions such as performing searches or placing an order with the online system 140. The ordering interface may be part of a client application operating on the client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The client device 100 may receive additional content from the online system 140 to present to a user. For example, the client device 100 may receive coupons, recipes, or item suggestions. The client device 100 may present the received additional content to the user as the user uses the client device 100 to place an order (e.g., as part of the ordering interface).

Additionally, the client device 100 includes a communication interface that allows a user to communicate with other users. This communication interface allows the user to input a text-based message to transmit to the client device 110 via the network 130. The client device 110 receives the message from the client device 100 and presents the message to the user of the client device 110. The client device 110 also includes a communication interface that allows the user to communicate with other users. The client device 110 transmits a message provided by the user to the client device 100 via the network 130. In some embodiments, messages sent between the client device 100 and the client device 110 are transmitted through the online system 140. In addition to text messages, the communication interfaces of the client device 100 and the client device 110 may allow the users to communicate through audio or video communications, such as a phone call, a voice-over-IP call, or a video call.

The client device 110 is a client device through which a user may interact with other client devices 100, the third-party computing system 120, or the online system 140. The client device 110 can be a personal or mobile computing device, such as a smartphone, a tablet, a laptop computer, or desktop computer. In some embodiments, the client device 110 executes a client application that uses an application programming interface (API) to communicate with the online system 140.

The third-party computing system 120 is a computing system operated by a third-party, for example, a retailer that interacts with the online system 140. As used herein, a “retailer” is an entity that operates a “retailer location,” which is a store, warehouse, or other building. The third-party computing system 120 stores and provides item data to the online system 140 and may regularly update the online system 140 with updated item data. For example, the third-party computing system 120 provides item data indicating which items are available at a location and the quantities of those items. Additionally, the third-party computing system 120 may transmit updated item data to the online system 140 when an item is no longer available at a location. Additionally, the third-party computing system 120 may provide the online system 140 with updated item prices, sales, or availabilities.

The client devices 100, 110, the third-party computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLMs, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 receives a query from a user, for example a natural language query that specifies a high-level intent of the user. The online system 140 uses a machine learning based language model to determine additional information based on the received query. The additional information may specify details of the user's intent in the query or specific attributes based on the query. For example, if the query concerns shopping for a specific occasion such as a birthday or a baby shower, the online system 140 uses the machine learning based language model to identify details of specific items that should be purchased for the occasion. The online system 140 may further obtain details of the items from a catalog associated with a specific retail store. The online system 140 may further obtain details of the items by performing a search using a search engine.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives an external corpus from the online system 140 and builds a structured index over the data using, for example, another machine learning based language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses to the query from the model serving system 150 and synthesizes a response. While the online system 140 can generate a prompt using the external data as context, oftentimes, the amount of information in the external data exceeds prompt size limitations configured by the machine learning based language model. The interface system 160 can resolve prompt size limitations by generating a structured index of the data and offers data connectors to external data sources as well as provide a flexible connector to the external corpus.

FIG. 1B illustrates an example system environment for an online system 140, in accordance with one or more embodiments. The system environment illustrated in FIG. 1B includes client devices 100, 110, a third-party computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

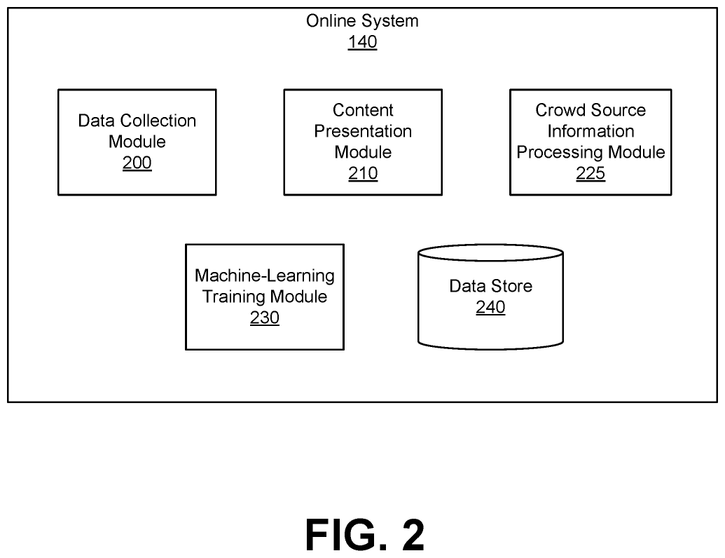

FIG. 2 illustrates an example system architecture for an online system 140, in accordance with some embodiments. The system architecture illustrated in FIG. 2 includes a data collection module 200, a content presentation module 210, a search module 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, preferences, favorite items, or stored payment instruments. The user data also may include default settings established by the user, such as a default retailer/retailer location, delivery location, or delivery timeframe. The data collection module 200 may collect the user data from sensors on the client device 100 or based on the user's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a user looked for the item but could not find it), the rate at which the item is found, or the popularity of the item. The data collection module 200 may collect item data from the client devices 100, 110.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, when the order was delivered, or a rating that the user gave the delivery of the order. In some embodiments, the order data includes user data for users associated with the order, such as user data for a user who placed the order.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a user based on whether the predicted availability of the item exceeds a threshold.

The search module 225 receives high level search queries, such as natural language queries from users, for example, an unstructured text input specifying a request to determine items needed for a particular occasion. The search module 225 uses the machine learning based language model to generate more specific queries that can be executed using a database or a search engine to obtain specific search results, for example, search results that identify specific types of items that the user may be interested in purchasing for a specific occasion.

In one or more embodiments, the online system 140 may additionally fine-tune parameters of the machine learning based language model using multiple instances of training data. An instance in the training data may include strings or sentences obtained by concatenating inputs and expected outputs of the machine learning based language model. For example, the training data may comprise natural language questions received from users with lists of items, item types, or categories of items associated with the natural language question. The training data may comprise natural language questions concatenated with contextual data describing users further concatenated with lists of items, item types, or categories of items associated with the natural language question. Contextual data describing users includes user profile information of the user, one or more previous interactions of the user with the online system, items previously selected by the user using the online system, browsing history of the user while interacting with the online system, and so on. The machine learning based language model receives an input sentence with missing tokens from the output portion of the input sentence and predicts the missing tokens. A loss function is computed by aggregating loss values obtained from the predicted tokens and the known tokens of the output portion of the sentences provided as training data. The errors obtained from the loss function are backpropagated to update parameters of the machine-learned model.

According to one or more embodiments, training data is generated from historical data. For example, items or item types associated with specific holidays or festivals are obtained by analyzing the items with high frequency of occurrence in transactions performed within a threshold time/days of the specific holidays or festivals. The training data may also be obtained from experts or by crowdsourcing. For example, users may specify the types of items or item types relevant to occasions such as birthdays, weddings, baby showers, housewarming, and so on.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

According to one or more embodiments, the online system 140 provides the information associating contextual information with items or item types to the interface system 160. For example, the sentences or textual data that associates various event types (e.g., birthdays, weddings, and so on) or festivals (Christmas, thanksgiving, and so on) with of items or item types frequently used for the corresponding events or festivals by users is provided to the interface system 160. The interface system 160 builds a structured index using this data, for example, another machine-learned language model or heuristics. The structured index comprises data structures that store information obtained from external sources, for example, a corpus of unstructured text representing the associations described herein. Examples of such an index include GPT Index and LlamaIndex. The index allows the system to connect the corpus of information with a machine-learned language model so that the answers to a prompt are based on the knowledge of the trained machine-learned language model as well as the information stored in the corpus. Accordingly, in the system as disclosed the answers to prompts requesting attributes or items/item types associated with a search query are based on knowledge of the trained machine-learned language model as well as the information stored in the corpus or user comments.

The data store 240 stores data used by the online system 140. For example, the data store 240 stores user data, item data, and order data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

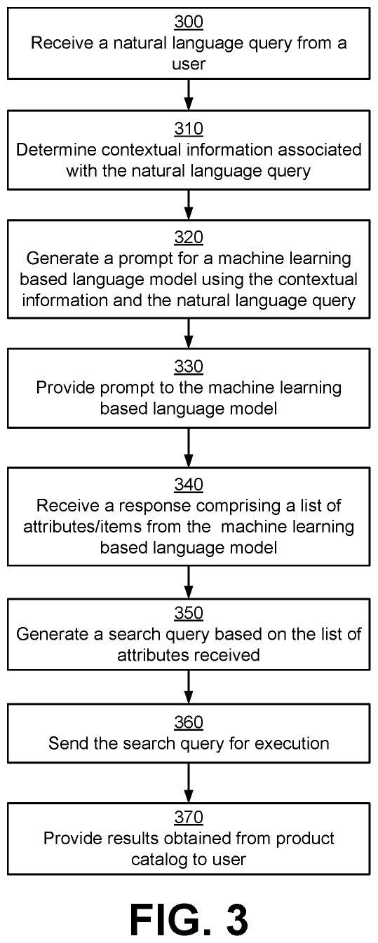

FIG. 3 is a flowchart for processing queries received from users, in accordance with one or more embodiments. Alternative embodiments may include more, fewer, or different steps from those illustrated in FIG. 3, and the steps may be performed in a different order from that illustrated in FIG. 3. These steps may be performed by a system (e.g., an online system such as the online system 140). Additionally, each of these steps may be performed automatically by the online system without human intervention.

The system receives 300 a natural language query from a client device of a user. The natural language query may concern a potential transaction for the user, for example, a potential transaction related to an online purchase that the user is interested in making. The natural language query may specify the high-level intent of the user but may not specify specific details of the potential transaction. For example, the user may specify that the user is interested in purchasing items necessary for a particular type of event, such as a kid's birthday party, a wedding, or the like. The user may specify that the user is interested in purchasing items for an office event, or that the user is interested in purchasing items for a camping trip, and so on. However, the query may not specify the specific details of the items that the user is interested in purchasing.

According to one or more embodiments, the system receives from the user a request for items associated with a particular type of event, without specifically identifying the items that the user wants to search. The system generates a prompt requesting the machine learning based language model to provide a list of items associated with the event, for example, items that users have previously bought in association with that type of event or items that users have searched for in connection with that particular type of event. The system receives the list of items from the machine learning based language model and generates a query that lists specific items identified by the machine learning based language model for searching, for example, in a database such as a product catalog database. The system may receive types of items from the machine learning based language model and search for instances of items that are available in a product catalog. For example, the machine learning based language model may specify that a cake may be suitable for a particular type of event, and the system may generate a query to identify specific types of cakes that are available in a database such as a product catalog. The system generates a search query configured to identify instances of a particular type of item in a database returned by the machine learning based language model. According to one or more embodiments, the system receives from the machine learning based language model, a broad category of items associated with events of a specified type and generates a query to look for specific types of items (or subcategories of items within the category of items) within a database such as a product catalog.

The system determines 310 contextual information associated with the natural language query. The system may determine contextual information that allows the system to identify specific details of the items that the user should purchase. The system may determine contextual information including user profile information of the user of the client device. The system may determine contextual information including demographic information of the user such as location of the user, gender of the user, ethnicity of the user, marital status of the user, financial status, and so on. The system uses the demographic information to further narrow the types of items that are relevant to the user's shopping. In some instances, any and/or all of the contextual information may only be accessed and used where the user has opted into and consented to such information being used to provide enhanced personalization features.

The system may extract contextual information based on information obtained in one or more previous interactions of the user with the online system. For example, the contextual information may include types of items previously selected by the user. The items may be selected for purchase during previous transactions. The items may be saved by the user in a list for consideration in future. The system may infer user profile information based on user interactions. For example, the system may determine whether the user has family and kids based on past purchases of items such as kids' toys, diapers, and so on.

The contextual information may include browsing history of the user while interacting with the online system. For example, the contextual information may include information identifying items accessed by the user while browsing through a catalog of a store. Additionally, or alternatively, the contextual information may include information identifying items accessed from search results returned by the online system during searches performed by the user.

The contextual information may include information identifying one or more retail stores associated with the user. For example, the retail stores may be the retail stores frequently used by the user. The retail stores may be saved as preferences by the user in the user profile of the user.

The system generates 320 a prompt for input to a machine learning based language model based on the natural language query and the contextual information. For example, if the natural language query specifies that the user is interested in purchasing items for a party organized at the user's home, the system may generate a prompt that includes the natural language query along with contextual information such as gender of the user, types of items previously purchased by the user that may be relevant to a party, age of the user, and other information to identify items that are relevant to the user.

The system provides 330 the prompt to the machine learning based language model for execution. The system receives 340 a response to the prompt from the machine learning based language model. The response may be a parse-able string of text that the system may further analyze to identify individual attributes. The response may include a set of attributes including, for example, specific details of the types of items that the user may be interested in. For example, the response may identify the type of food and drinks that may be relevant to the party.

According to one or more embodiments, the system may generate a prompt that asks the machine learning based language model to obtain specific details of the user's intent according to the query or to identify the main concept in the query. In response to the prompt, the machine learning based language model may tag keywords indicating the main concept of the user's query.

The system further generates 350 a search query based on the set of attributes. The search query may be a query for searching for items in a database, for example, a product catalog of retail stores. By searching through a database, the system is able to identify specific items, for example, products of product types. The search query may identify a broad category of items (e.g., products such as pasta, wheat flour, and so on), whereas the system can identify specific products (e.g., brand names of a product type) that are available with a specific retail store by searching through the database. The search query may be a query for searching for items using a search engine. The system sends 360 the search query for execution. For example, the search query may be executed using the database or the search engine.

The system receives search results in response to the search query and provides 370 the search results to the client device of the user. The system may send a message to the user with the search results. The system may add one or more items selected based on the search to a shopping cart of the user. The system may send a request to a personal shopper to purchase the items on behalf of the user. The system may send a request to the user to approve these actions before the system automatically performs the actions.

According to one or more embodiments, the system interacts with the machine learning based language model to identify additional information that would be useful for providing specific answers to the query received from the user. The system requests the user to provide the additional information so as to be able to provide more specific information. For example, if the machine learning based language model determines that the user should include turkey in the shopping list, the system may interact with machine learning based language model to determine what additional information would help narrow the type of turkey that should be added to the shopping list. Based on the interaction with the machine learning based language model, the system may provide a message to the user, requesting the user to further narrow the search. An example message is “do you want turkey for a sandwich or a whole turkey for thanksgiving dinner.” The system accordingly iterates with the machine learning based language model and the user to generate specific queries for providing the most specific and relevant results to the user.

According to one or more embodiments, the system interacts with the machine learning based language model to identify relevant information for each item that is identified by the system for inclusion in the shopping list for the user. For example, the system may interact with the machine learning based language model to determine the attributes of a particular item or a type of item for a given context. For example, if the system determines that the item that is relevant to the user's natural language question is flowers, the system may further provide contextual information to the machine learning based language model to determine the type of flowers that the users should buy based on the occasion. The system may perform multiple iterations with the user and the machine learning based language model to identify attributes relevant to the search query. For example, the system may interactively ask the user to provide additional contextual information and generate appropriate prompts for the machine learning based language model to determine attributes to be added to the search query for narrowing the search based on the contextual information. For example, the system may ask the user for any dietary restrictions and specifies in the prompt to identify items that satisfy the dietary restrictions. Accordingly, the machine learning based language model ensures that any food items identified in the response satisfy dietary restrictions of the user. The system interacts with the user regarding any other preferences and includes them in the prompt.

According to one or more embodiments, the system may interact with the machine learning based language model to determine the most commonly asked questions by other users in relation to specific items such as tofu, tempeh, or seitan. The system generates prompt asking the machine learning based language model to provide most commonly asked questions related to the search query received from the user. The machine learning based language model is executed using the prompt to generate the most commonly asked questions related to the search query received from the user. These questions may include questions such as how these items are cooked or questions related to recipes based on these items. The system displays the information obtained from the machine learning based language model to the user, for example, via a user interface. Accordingly, the user interface may display a pane with information that “people often ask” in connection with a specific item.

### Additional Considerations

The foregoing description of the embodiments has been presented for the purpose of illustration; many modifications and variations are possible while remaining within the principles and teachings of the above description. Embodiments comprise computer-implemented methods comprising steps of processes described herein. Embodiments comprise non-transitory computer readable storage medium storing instructions that when executed by one or more computer processors cause the one or more computer processors to perform steps of methods disclosed herein. Embodiments comprise computer system comprising one or more computer processors and a non-transitory computer readable storage medium storing instructions that when executed by one or more computer processors cause the one or more computer processors to perform steps of method disclosed herein.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
at a computer system comprising a processor and a computer-readable medium:
receiving, by an online system, from a client device of a user, a natural language query, wherein the natural language query specifies a particular type of event;
identifying contextual information associated with the natural language query;
generating a prompt for input to a machine learning based language model based on the natural language query and the contextual information;
providing the prompt to the machine learning based language model for execution;
receiving a response to the prompt from the machine learning based language model, the response comprising information associated with the event;
generating a search query based on response;
sending the search query for execution;
receiving search results in response to the search query; and
sending the search results to the client device.

2. The method of claim 1, wherein sending the search query for execution comprises:
sending the search query generated based on the response received from the machine learning based language model to a database associated with an online system,
wherein receiving the search results in response to the search query comprises receiving the search results from the database associated with the online system.

3. The method of claim 1, wherein the prompt generated for providing as input to the machine learning based language model requests the machine learning based language model to list items associated with the particular type of event.

4. The method of claim 3, wherein the response comprises one or more types of items associated with the particular type of event from the machine learning based language model, and wherein the search query is configured to identify in a database, instances of a particular type of item associated with the particular type of event obtained from the machine learning based language model.

5. The method of claim 3, wherein the response from the machine learning based language model comprises one or more categories of items associated with the particular type of event, and wherein the search query is configured to identify in a database, subcategories of items associated with the particular type of event.

6. The method of claim 1, wherein identifying the contextual information comprises identifying user profile information of the user of the client device.

7. The method of claim 1, wherein identifying the contextual information comprises identifying information obtained in one or more previous interactions of the user with the online system.

8. The method of claim 1, wherein identifying the contextual information comprises identifying information describing items previously selected by the user using the online system.

9. The method of claim 1, wherein identifying the contextual information comprises identifying browsing history of the user while interacting with the online system.

10. A non-transitory computer readable storage medium storing instructions that when executed by one or more computer processors cause the one or more computer processors to perform steps comprising:
receiving, by an online system, from a client device of a user, a natural language query, wherein the natural language query specifies a particular type of event;
identifying contextual information associated with the natural language query;
generating a prompt for input to a machine learning based language model based on the natural language query and the contextual information;
providing the prompt to the machine learning based language model for execution;
receiving a response to the prompt from the machine learning based language model, the response comprising information associated with the event;
generating a search query based on response;
sending the search query for execution;
receiving search results in response to the search query; and
sending the search results to the client device.

11. The non-transitory computer readable storage medium of claim 10, wherein instructions for sending the search query for execution cause the one or more computer processors to perform steps comprising:
sending the search query generated based on the response received from the machine learning based language model to a database associated with an online system,
wherein receiving the search results in response to the search query comprises receiving the search results from the database associated with the online system.

12. The non-transitory computer readable storage medium of claim 10, wherein the prompt generated for providing as input to the machine learning based language model requests the machine learning based language model to list items associated with the particular type of event.

13. The non-transitory computer readable storage medium of claim 12, wherein the response comprises one or more types of items associated with the particular type of event from the machine learning based language model, and wherein the search query is configured to identify in a database, instances of a particular type of item associated with the particular type of event obtained from the machine learning based language model.

14. The non-transitory computer readable storage medium of claim 12, wherein the response from the machine learning based language model comprises one or more categories of items associated with the particular type of event, and wherein the search query is configured to identify in a database, subcategories of items associated with the particular type of event.

15. The non-transitory computer readable storage medium of claim 10, wherein the identifying contextual information comprises identifying user profile information of the user of the client device.

16. The non-transitory computer readable storage medium of claim 10, wherein identifying the contextual information comprises identifying information obtained in one or more previous interactions of the user with the online system.

17. The non-transitory computer readable storage medium of claim 10, wherein identifying the contextual information comprises identifying information describing items previously selected by the user using the online system.

18. A computer system comprising:
one or more computer processors; and
a non-transitory computer readable storage medium storing instructions that when executed by one or more computer processors cause the one or more computer processors to perform steps comprising:
receiving, by an online system, from a client device of a user, a natural language query, wherein the natural language query specifies a particular type of event;
identifying contextual information associated with the natural language query;
generating a prompt for input to a machine learning based language model based on the natural language query and the contextual information;
providing the prompt to the machine learning based language model for execution;
receiving a response to the prompt from the machine learning based language model, the response comprising information associated with the event;
generating a search query based on response;
sending the search query for execution;
receiving search results in response to the search query; and
sending the search results to the client device.

19. The computer system of claim 18, wherein instructions for sending the search query for execution cause the one or more computer processors to perform steps comprising:
sending the search query generated based on the response received from the machine learning based language model to a database associated with an online system,
wherein receiving the search results in response to the search query comprises receiving the search results from the database associated with the online system.

20. The computer system of claim 18, wherein the prompt generated for providing as input to the machine learning based language model requests the machine learning based language model to list items associated with the particular type of event.
